(19) United States
(12) Patent Application Publication
(10) Pub. No.: US 2004/0168611 A1
(43) Pub. Date: Sep. 2, 2004

(54) Composition for running surface layer or capping layer

(76) Inventors: Jean-Marc Dresin, Chomerac (FR); Patrick Guiraud, La Queue Lez Yvelines (FR); Claude Stock, Soleymieu (FR)

Correspondence Address: BURNS DOANE SWECKER & MATHIS L L P, POST OFFICE BOX 1404, ALEXANDRIA, VA, 22313-1404, US

(21) Appl. No.: 10/468,767

(22) PCT Filed: Feb. 19, 2002
(86) PCT No.: PCT/FR02/00629

(30) Foreign Application Priority Data
Feb. 21, 2001 (FR) 01/02332

(51) Int. Cl. C08K 3/00; C09D 4/00; C09D 101/00; C04B 7/00

(52) U.S. Cl. 106/273.1; 524/2; 524/59; 106/713

(57) ABSTRACT

The invention concerns a composition for producing a running surface layer or capping layer, in particular for roads or industrial floors. The composition includes a non-modified bitumen emulsion, a hydraulic binder, aggregates and optionally water. The composition has hydraulic binder content C1 between 12 wt. % and 30 wt. % relative to the total weight of the dry constituents of the composition; the ratio R1 of the sum of bitumen volumes and hydraulic binder over the volume of aggregates ranges is between 20% and 150%; and the non-modified bitumen emulsion is at least a non-ionic surfactant. A method for preparing the composition and its use for producing a running surface layer or capping layer is also disclosed.

The invention relates to a composition for producing a wearing course or capping layer, especially for roadways or industrial floors, to a process for preparing this composition, and to its use.

A modern wearing course must meet a number of requirements. In particular, it must:

be capable of withstanding traffic pounding, that is to say it must have good grip at different speeds, good surface evenness (for a high level of driving comfort), not form ruts under the effect of repeated loads, have good fatigue strength, and not be sensitive to aging owing to the effect of water, UV, deicing salts);

not be noisy;

be impermeable, in order to avoid degradation of the lower courses;

be easy to manufacture and process;

be inexpensive;

present the minimum of risks for site workers, roadside residents and users;

be able to be recycled; and

be esthetic and fit in with the scenery.

The most recent techniques employed for producing wearing courses relate to bituminous concretes (BC), the most common of which are thin bituminous concretes (TBC), very thin bituminous concretes (VTBC) and ultrathin bituminous concretes. These concretes are formed from aggregates, a filler (limestone or lime) and bitumen.

These techniques involve the preparation of the concrete composition in a central coating plant, by mixing the constituents heated to 150° C., transport to the work site, laying and compacting. They make it possible to produce a wearing course that reaches its optimum performance characteristics in a few tens of minutes. However, they do have a number of drawbacks:

they pose safety problems to workers who are manufacturing and processing hot mixes;

they produce emanations of vapors that are environmentally dangerous and polluting;

they produce dust and give off unpleasant smells;

they form ruts too easily; and

they are sensitive to temperature and to creep.

With a view to alleviating these drawbacks and improving the safety of site workers, users and roadside residents, various attempts have been made to develop techniques for cold mixes, these being based on hybrid binders based on bitumen emulsions and cement, and meeting the required operating specifications and qualities.

Thus, French patents No. 1 453 419 and No. 1 465 689 relate to cold bituminous mortars formed at least partly from Portland-type cement, a detergent, an anionic or cationic bitumen emulsion and aggregates.

The mortars described in these patents have the major drawback of containing substantial amounts of air, which considerably impairs their mechanical performance.

The subject of French patent No. 1 493 035 is a cold bituminous mix allowing the production of sound-deadening screeds or an isophonic laying mortar for floor coverings formed at least partly from cement, detergent, acid or alkaline bitumen emulsion, silica-lime aggregates and/or rice husk ash or any other appropriate material not deteriorating the bituminous mix. This bituminous mix does not allow a wearing course having satisfactory properties, such as mechanical strength, to be obtained. Furthermore, the final mix must always be prepared using a two-step process.

The subject of European patent application No. 380,704 is a mix comprising aggregates, an asphalt emulsion, cement, an inorganic hydraulic material and water. The surfaces of the aggregates are coated with asphalt particles formed by the coalescence of the asphalt emulsion. The inorganic hydraulic material and the water are present in the interstices between the aggregates. This mix does not allow a wearing course having satisfactory properties, such as mechanical strength, to be obtained. Furthermore, the final material must always be prepared using a two-step process.

European patent application No. 545,740 relates to a process for the cold double treatment of a granular material intended for road making. According to that process, a premix is prepared consisting of a granular material and a first, hydraulic binder, such as a cement, or a hydrocarbon, such as bitumen, containing, where appropriate, surfactant stabilizers, and this premix is transferred to mixing members within which is added thereto a second, hydrocarbon or hydraulic, binder so as to obtain a final mix which is spread onto a roadway on site. However, this final mix does not allow a wearing course having satisfactory properties, such as mechanical strength, to be obtained. Furthermore, it must always be prepared using a two-step process.

French patent application No. 2 661 173 relates to a composite binder formed, on the one hand, from an aqueous emulsion of at least one hydrocarbon binder and, on the other hand, at least one hydraulic binder. However, this binder must absolutely also contain at least one admixture intended to control the rate of setting of the hydraulic binder so as to obtain a liquid product with a viscosity of less than 1 Pa.s.

French patent application No. 2 725 196 proposes a composite concrete for roadways and industrial floors comprising granulates, a composite binder that combines a hydraulic binder and a hydrocarbon binder, water and one or more admixtures. The relative proportion by volume of the hydraulic binder and the hydrocarbon binder to the granulates is greater than 12%. The concretes cited as examples in that patent application contain small amounts of cement (around 6% by weight with respect to the total weight), high water/cement ratios (W/C values greater than 0.75) and they involve the use of a cement set retarder. They therefore do not allow a wearing course having satisfactory properties, such as mechanical strength, to be obtained. In addition, it is necessary for the cement/bitumen hybrid binder to be prepared separately, before the introduction of the granulates, since mixing the two binders simultaneously with the granulates, in the same mixer, does not result in a completely uniform composite concrete, whatever the amount of cement.

International application No. WO 00/004096 relates to an aqueous bitumen emulsion containing, expressed in percentages of the total weight of the emulsion:

50 to 70% of bitumen;

0.5% to 10% of a particular surfactant; and

qsp 100% of water.

This international application also relates to a gravel/sand composition for road base courses, based on a hydraulic binder of the Portland or equivalent cement clinker or slag type, containing 0.5 to 6% by weight of the bitumen emulsion.

Finally, this international application furthermore relates to the use of the emulsion, in particular for formulating a composition for cold products substituting for hot mixes in the case of road wearing courses or road base and forming courses, this composition possibly containing a hydraulic binder that may be a Portland cement or equivalent, an aluminous cement or a calcium sulfate, together with inorganic fillers such as aggregates, sand or silica.

However, this international application provides no details as to the hydraulic binder and bitumen contents that are necessary to obtain a wearing course composition meeting the required specifications and properties.

A subject of the invention is therefore a composition comprising an unmodified bitumen emulsion, a hydraulic binder, aggregates, and optionally water, and being characterized in that:

its content C1 of hydraulic binder is between 12% and 30% by weight with respect to the weight of all of the dry constituents of the composition;

the ratio R1 of the sum of the volumes of unmodified bitumen and of hydraulic binder to the volume of aggregates is between 20% and 150%; and

the unmodified bitumen emulsion includes at least one nonionic surfactant.

This composition causes no flocculation of the unmodified bitumen emulsion during mixing of the constituents.

The concrete obtained after its hydraulic setting and hardening satisfies all of the performance characteristics required for a road wearing course.

The formulation of such a composition therefore allows it to be processed on sites with the conventional means used in civil engineering work.

Furthermore, the composition according to the invention may be manufactured:

either by a central mixing plant for ready-mixed concrete using the conventional operating method of manufacturing concrete, in a single step, and delivered to sites like a conventional concrete and within the same time scales as the latter by means of mixer trucks or truck mixers;

or by a central mixing plant for cold mixes, again in a single step, and delivered by a truck mixer or mixer truck.

A subject of the invention is also a process for preparing a composition according to the invention, in which the hydraulic binder, the bitumen emulsion, the aggregates and optionally water are mixed in a single step.

This process consequently has the advantage of comprising only a single step.

Another subject of the invention is a concrete obtained by the hydraulic setting and hardening of the composition according to the invention.

Yet another subject of the invention is the use of the concrete composition according to the invention for producing a wearing course.

Yet one more subject of the invention is a process for manufacturing a wearing course, comprising the application of a composition according to the invention, the hydraulic setting of the composition and its hardening.

Other features and advantages of the invention will now be described in detail in the description that follows.

### DETAILED DESCRIPTION OF THE INVENTION

Composition According to the Invention

The composition according to the invention therefore has a content C1 of hydraulic binder between 12% and 30% by weight with respect to the weight of all of the dry constituents of the composition.

In the present description, the term “dry constituents” is understood to mean all of the dry elements of the formulation, excluding the bitumen, that is to say the hydraulic binders and the aggregates.

In addition, the ratio R1 of the sum of the volumes of bitumen and hydraulic binder to the volume of aggregates is between 20% and 150%.

To calculate R1, the following are considered in the present description:

the hydraulic binder has a density of 3150 kg/m³;

the bitumen has a density of 1050 kg/m³; and

the aggregates have a density of 2650 kg/m³.

The aggregates are generally fillers, sands or granulates.

The term “fillers” is understood to mean aggregates having a mean diameter of less than about 80 μm.

Sands are aggregates having a mean diameter of between 0 and 4 mm.

The granulates have a mean diameter of greater than about 4 mm and preferably less than 20 mm.

The aggregates used in the invention are those commonly used by a person skilled in the art, such as siliceous, calcareous, silico-calcareous and granitic granulates, eruptive rocks, calcareous, siliceous or granitic fillers, siliceous, calcareous or granitic sands, etc.

Optionally, the aggregates may be recovered aggregates obtained after operations carried out on roadways, such as milling operations, etc.

Although it is possible optionally to provide, in the compositions according to the invention, fibbers such as rock fibbers, glass fibbers, organic fibbers, such as plant fibbers, or synthetic fibbers, such as polyamide, poly(vinyl chloride), polyester, polyethylene or polypropylene fibbers, or the like, a considerable advantage afforded by the invention is that the compositions according to the invention do not need to include fibbers. This is because the properties desired for a high-quality wearing course (toughness, flexibility, impact strength, flexural strength) are generally satisfied by compositions according to the invention without fibbers. This makes it easier to process the material (fibbers are often difficult to disperse) and it also adds an economic advantage.

Thus, according to a preferred embodiment of the invention, the fibber content is less than 0.2% by volume with respect to the total volume of the hydraulic binder, the bitumen emulsion, the aggregates, the water and, where appropriate, the other admixtures.

The hydraulic binder is generally formed from at least one hydraulic binder chosen from the group consisting of Portland cements or equivalents, with or without secondary constituents, slag-based cements, aluminous cements, hydraulic road binders, ground cement clinker, as well as mixtures thereof with pozzolanic materials such as, for example, slags, fly ash or silica fume.

Another major advantage of the invention is that the bitumen emulsion comprises an unmodified bitumen. This is because it is known in the prior art to use modified bitumens (that is to say those mixed with rubbers or thermoplastic high polymers) so as to improve the rotting resistance of the wearing courses. However, the bitumens of the invention do not need to be polymer-modified, this being a major economic advantage since the formulations according to the invention exhibit excellent rotting resistance even without modified bitumen.

In general, use is made of at least one unmodified bitumen chosen from bitumens that can be emulsified at atmospheric pressure.

Preferably, the unmodified bitumen is chosen from the group formed by bitumens of grades having a penetrability index (expressed in tenths of millimeters of penetration according to the NF-T-66-004 standard) of between 40 and 220, bitumens of deasphalted grades, bitumens of synthetic grades, distillation bitumens, blown bitumens, semi-blown bitumens, blends of these bitumens with one another, and these blends plasticized with the aid of polymers.

The unmodified bitumen emulsion furthermore includes at least one nonionic surfactant so as to reduce the risks of flocculation.

The composition according to the invention may furthermore include various admixtures used by those skilled in the art of mortars and concretes based on hydraulic binders, such as accelerators, retarders, plasticizers, superplasticizers, water-repellency agents, etc.

Preferably, the water/hydraulic binder (W/C) mass ratio is at most equal to 0.7. Here this is the total water, that is to say the water provided by the bitumen emulsion to which is optionally added the water provided independently of the bitumen emulsion.

When it is desired to obtain a self-placing composition, that is to say one that is simply laid without compacting it, the W/C mass ratio is generally greater than 0.4, preferably between 0.43 and 0.7.

When it is desired to obtain a composition to be compacted, the W/C mass ratio is generally less than 0.4, preferably less than or equal to 0.35.

According to a preferred embodiment of the invention, the composition for concrete according to the invention has a C1 content of hydraulic binder between 13 and 25% by weight with respect to the weight of all of the dry constituents of the composition and the ratio R1 of the sum of the bitumen and hydraulic binder volumes to the aggregate volume is between 25 and 70%.

According to another preferred embodiment of the invention, the bitumen emulsion is similar to that disclosed in the international application No. WO 00/004096, that is to say it comprises, expressed in percentages of the total weight of the emulsion:

30 to 70% of unmodified bitumen;

0.5 to 10% of nonionic surfactant;

0 to 5% of thickener;

0 to 1% of antifoam; and

qsp 100% of water;

the nonionic surfactant being formed from at least one nonionic surfactant chosen from the group consisting of ethylene oxide/propylene oxide copolymers, ethoxylated and/or propoxylated epoxydized surfactants, polyvinyl alcohols of molecular mass between 10 000 and 150 000, and ethoxylated fatty alcohols.

The constituents of this emulsion, especially the bitumen, the surfactant, the thickener and the antifoam, may therefore be chosen from those disclosed in that international application No. WO 00/004096.

Such an emulsion may advantageously be used in formulations containing high contents of hydraulic binders, without breaking, so as to be uniformly dispersed during the mixing with the other ingredients and so as to pose no rheology problems.

Preparation of the Composition According to the Invention

The composition according to the invention has two advantages, namely of being able to be prepared cold and by a process comprising only a single step.

The process therefore consists simply in mixing the ingredients, namely the hydraulic binder, the bitumen emulsion, the aggregates and the water, generally in a pug mill mixer.

This may be carried out in a central mixing plant for ready-mixed concrete, the composition then being transported, like ready-mixed concrete, by means of a truck mixer or mixer truck to its site of use where it will be processed cold by the conventional means used in civil engineering works.

The preparation of the composition according to the invention may also be carried out in a central mixing plant for cold mixes using, for example, a mixer with a feed screw and delivered to the site by means of truck mixers.

A beneficial feature of the composition according to the invention is in fact that, unlike the processes of the prior art, in the composition according to the invention the breaking of the bitumen emulsion is no longer caused just by the mixing of the emulsion with the granulates, but is caused by the slow and considerable reduction in the volume of water that results from the hydration of the cement, since the hydration of the cement consumes a significant amount of water.

This breaking coincides with the start of cement setting and hardening and does not alter the necessary time scale between manufacture and laying. Such kinetics are consistent with the on-site processing times.

Use

All the operations using the composition according to the invention therefore have the major advantage of being carried out cold. This minimizes any risk regarding the safety of workers and avoids any pollution.

The consistency of the composition according to the invention depends on its W/C ratio.

The manufacture of a wearing course comprises the application of a composition of the invention, the hydraulic setting of the composition and its hardening.

When the composition according to the invention has high WIC ratio values, it is self-placing and its application is therefore carried out by self-placement.

The wearing courses formed from the self-placing composition according to the invention can therefore be put into service in a short time, generally from 2 h to 20 h after being laid.

With low W/C ratio values, the consistency of the concrete composition according to the invention is that of a material to be compacted.

The manufacture of a wearing course then includes a compacting step, which may be carried out with the equipment conventionally used. The wearing courses formed from the composition to be compacted according to the invention (and which are consequently laid with compacting) may be put into service immediately after the end of compacting.

The concrete obtained during the hardening of the composition according to the invention therefore has great flexibility, it does not crack and it possesses high mechanical strength, making it particularly appropriate for use as a wearing course, since wearing courses are subjected to high and repeated external stresses.

### EXAMPLES

The following examples illustrate the present invention without however limiting the scope thereof:

In these examples, all the bitumens are unmodified bitumens.

### Example 1

### Preparation of the Emulsion

A first emulsion BE1 containing 60% bitumen, having the formulation below, was prepared:

| | |
|---|---|
| 70/100 bitumen: | 60% |
| Copolymer LC 818 C: | 3.5% |
| Empilan NP 15: | 0.5% |
| Kelcocrete K1C 376: | 0.05% |
| Water: | qsp 100%. |

The 70/100 bitumen, available from Shell, is a standard-grade bitumen (of 70 to 100 mm penetrability).

The copolymer LC 818 C is a nonionic surfactant available from Cognis. It is an ethylene oxide/propylene oxide copolymer of about 2000 molecular mass.

Empilan NP 15 is a nonionic surfactant and a nonylphenol ethoxylated by 15 ethoxy groups.

These two nonionic surfactants constitute an emulsifier system that does not have any influence on the setting of the cement.

Kelkocrete KlC 376 is a welan gum available from Monsanto. It is a thickener of the polysaccharide type, that prevents sedimentation during storage.

The emulsion was produced by maintaining an aqueous phase containing water, the two surfactants and the thickener, with stirring at 60° C., and then the bitumen, melted at 140° C., was poured into the aqueous phase and stirred at a rate of 1000 rpm.

### Example 2

A concrete composition A of the self-placing type, having the formulation below, was prepared cold by using the bitumen emulsion BE1 of example 1:

| | |
|---|---|
| 6 to 10 mm granulates: | 80% |
| Portland cement: | 20% |
| Bitumen emulsion: | 8.3 ppc |
| W/C ratio: | 0.45. |

The granulates were porphyry granulates from the Rivolet quarry.

The cement was CEM1 52, 5R from Saint-Pierre-La-Cour.

“ppc” denotes “parts per 100 parts of the cement/granulates mix”. The content of bitumen alone was therefore 5 ppc.

This composition A therefore had a content C1 of 20% and a ratio R1 of 36.8%.

### Example 3

A concrete composition B of the type to be compacted, having the same formulation as that of example 2, was prepared cold. Only the W/C ratio was different: in this case it was 0.32.

In this composition B, C1=20% and R1=36.8%.

### Example 4

### Comparative Example

A bituminous composition C of the prior art, of the BBM type (containing no cement) having the formulation below, was prepared hot:

| | |
|---|---|
| 0 to 2 mm porphyry sand: | 35% |
| 6 to 10 mm porphyry granulates: | 63% |
| Filler: | 2% |
| 35/50 Bitumen: | 5.4 ppc |

### Example 5

Twelve test pieces were cast from the compositions of concrete A and B (according to the invention) and C (prior art) as per the NF P 98-251-1 standard for Duriez Tests.

E′ denotes test pieces kept under water and E denotes those kept in the air.

Compressive strength tests where then carried out on the test pieces. The results are given in the table below, in which “s/S” represents the ratio of the strength of the test pieces E′ to the strength of the test pieces E.

| | Compressive strength | | | | | |
|---|---|---|---|---|---|---|
| | Test pieces of composition: | | | | | |
| Test piece | A | | B | | C | |
| E | 9.2 | MPa | 11.4 | MPa | 11 | MPa |
| E′ | 8.8 | MPa | — | | 10.3 | MPa |
| s/S | 0.96 | | — | | 0.94 | |
| Density | 2.00 | | 2.20 | | 2.10 | |

For a thin bituminous concrete (BBM) of class 3, an S value of at least 6 MPa and an s/S ratio of at least 0.8 are required by the NF P 98-132 standard.

It is therefore apparent that the test pieces of composition A and those of composition B are completely satisfactory, as they have properties equivalent to those of the prior art.

### Example 6

Rutting tests (NF P 98-256-1 standard) were carried out on compositions A, B and C of examples 2, 3 and 4.

These tests consisted in simulating road traffic on a test piece, by repeatedly subjecting it to the passage of a wheel and by measuring the depth of the rut after a certain number of cycles.

The test pieces were slabs prepared from compositions A, B and C and were left to rest for at least three days after they were cast.

The test conditions were the following:

slab dimensions: 500 mm×180 mm×100 mm;

test temperature: 60° C.;

tire inflation pressure: 0.6 MPa;

force applied to the tire: 5000 N;

load time: 0.1 s.

Test piece A (self-placing formulation) was laid by self-placement, applying a few shakes to the mold.

Test piece B was laid with compacting using a pneumatic-tired roller compactor.

The results are given in the table below.

| Number of | | | |
|---|---|---|---|
| cycles | Test piece A | Test piece B | Test piece C |
| 1 000 | 0.1% | 0.1% | 1.6% |
| 10 000 | 0.15% | 0.1% | 2.9% |
| 30 000 | 0.2% | 0.1% | 4.0% |
| 100 000 | 0.25% | 0.1% | — |

Since the rutting according to the standard (NF P 98-256-1) has to be less than 10%, that is to say 10 mm for a 100 mm thickness, after 30 000 tire pass cycles the concrete test pieces A and B according to the invention were completely satisfactory.

### Example 7

Cylindrical test pieces 16 cm in diameter and 32 cm in height, formed from compositions A and B of examples 2 and 3, were prepared by casting in a mold.

They were removed from the mold 24 hours after casting and the test pieces were kept for seven days at 20° C. and 50% relative humidity.

Compressive modulus measurements were then carried out on the test pieces.

The NF P 98-260-1 standard relating to the determination of the modulus and the loss of linearity sets a value of not less than 7 GPa.

The NF P 98-260-2 standard relating to the complex modulus sets a value of not less than 5.4 GPa.

The values measured on the test pieces of concrete according to the invention were 11 GPa. They were therefore well above the minimum required by the standards.

### Example 8

Other bitumen emulsions according to the invention, BE2, BE3, BE4, BE5, BE6 and BE7, having the formulations below, were prepared:

| | | | | | | Other | |
|---|---|---|---|---|---|---|---|
| | Bitumen | | Water | Surfactant | | admixture | |
| | Type | % | % | Type | % | Type | % |
| BE2 | D | 63 | 33 | LC818C | 3.5 | RG | 0.05 |
| | | | | NP 15 | 0.5 | | |
| BE3 | S | 62 | 36 | FA23, 20 | 2 | RG | 0.05 |
| BE4 | S | 62 | 36.5 | LC818C | 1 | RG | 0.05 |
| | | | | NP 15 | 0.5 | | |
| BE5 | S | 65 | 31 | LC818C | 3.5 | RG | 0.05 |
| | | | | L XL1400 | 0.5 | | |
| BE6 | S | 60 | 35 | L TO8 | 5 | K1C 376 | 0.05 |
| BE7 | T | 63 | 33 | LC818C | 3.5 | RG | 0.05 |
| | | | | NP 15 | 0.5 | | |

In this table, the abbreviations mean:

LC 818C=Copolymer LC 818 C from Cognis;

FA23,20=Nonionic surfactant FA23PO,20OE. This is a copolymer containing 20 ethylene oxide units and 23 propylene oxide units;

L TO8=Nonionic surfactant Lutensol TO8, available from BASF. This is an ethoxylated fatty alcohol containing eight ethylene oxide groups;

NP 15=Empilan NP 15;

L XL1400=Nonionic surfactant Lutensol XL 1400, available from BASF. This is an ethoxylated propylheptanol containing 14 ethylene oxide groups;

RG=Xanthan gum with the brand name Rhodopol G, available from Rhodia;

KlC 376=Kelcocrete K1C 376;

Bitumen D, available from Conoco-Koch is a bitumen of standard grade and 85/100 mm penetrability;

Bitumen S available from Shell is a bitumen of standard grade and 70/100 penetrability;

Bitumen T available from Petro Canada (Oakville refinery) is a bitumen of standard grade and 160/180 penetrability.

These emulsions were prepared according to various operating protocols:

The preparation of the aqueous phase was identical to that described in the case of BE1, and the bitumen was heated in the same way as for BE1:

for BE2: the mixes were supplied using pumps into a laboratory colloidal mill;

for BE7: the mixes were supplied using pumps into an industrial colloidal mill; and

for BE3 to BE6: the operating protocol was the same as that used for preparing BE1.

### Example 9

Concrete compositions D and F (outside the invention) and G and H (according to the invention) of the type to be compacted, having the formulations below, were prepared cold using emulsion BE2:

| | Compositions | | | |
|---|---|---|---|---|
| | D | F | G | H |
| Cel cement (%) | 10 | 10 | 10 | 30 |
| Slag (%) | — | — | 10 | — |
| Granulate (%) | 70 | 80 | 70 | 64 |
| Sand (%) | 10 | 10 | 10 | 6 |
| Filler (%) | 10 | — | — | — |
| Bitumen in emulsion | 5 | 5 | 5 | 5 |
| form (ppc) | | | | |
| W/C ratio | 0.35 | 0.36 | 0.44 | 0.2 |
| Content C1 | 10% | 10% | 20% | 30% |
| Ratio R1 | 23.4% | 23.4% | 36.8% | 54.1% |

Cement Ce1 was a CEM 52.5R cement from the cement works of Lafarge Ciments, located in Saint Pierre la Cour (France)

The slag came from the milling station of Lafarge Ciments located in Fos sur Mer (France).

The filler was a Betocarb P2 calcareous filler coming from the quarry in Tacon (France) and available from MEAC.

The granulates and the sand P used in D, G and H were porphyry aggregates coming from the quarry in Rivolet (France) and available from Lafarge Granulats, having particle size classes of 0-2 mm, 4-6 mm and 6-10 mm.

The granulates and the sand used in F were siliceous aggregates coming from the quarry in Challans (France) and available from Sablieres Palvadeau, having particle size classes of 0-4 mm, 4-8 mm and 8-12 mm.

### Example 10

Cylindrical test pieces having dimensions of 80 mm×80 mm of compositions D, F (outside the invention) and G and H (according to the invention) of example 9 were cast using the operating protocol of example 5.

The compressive strength tests, carried out according to the operating protocol of example 5, gave the following results:

| | Compressive strength | | | | | | | |
|---|---|---|---|---|---|---|---|---|
| | Test piece composition | | | | | | | |
| Test piece | D | | F | | G | | H | |
| E | 9.9 | MPa | 4.6 | MPa | 11.1 | MPa | 16 | MPa |
| E′ | 7.5 | MPa | 4.2 | MPa | 11.3 | MPa | 15.7 | MPa |
| s/S | 0.75 | | 0.91 | | 1.02 | | 0.98 | |
| Density | 2.28 | | 2.19 | | 2.31 | | 2.32 | |

These examples clearly show that only the compositions according to the invention make it possible to obtain test pieces having sufficient mechanical strength while meeting the conditions of the Duriez test, these conditions being specified by the standards cited in example 5.

It may also be seen that compressive strength values much greater than the values required by the standard are achieved with the compositions according to the invention.

### Example 11

Concrete compositions I, J, K, L and M according to the invention, of the type to be compacted, having the formulations below, were prepared cold using the bitumen emulsions of example 8:

| | | Compositions | | | | |
|---|---|---|---|---|---|---|
| | | I | J | K | L | M |
| Cement | Type | Ce1 | Ce2 | Ce3 | Ce4 | Ce5 |
| | % | 20 | 20 | 20 | 20 | 20 |
| Granulate | Type | P | S | P | G | P |
| | % | 70 | 70 | 70 | 70 | 70 |
| Sand | Type | P | S | P | G | P |
| | % | 10 | 10 | 10 | 10 | 10 |
| Bitumen in | Type | EB3 | EB4 | EB5 | EB6 | EB7 |
| emulsion | ppc | 5 | 5 | 5 | 5 | 5 |
| form | | | | | | |

| | | | | | |
|---|---|---|---|---|---|
| W/C ratio | 0.22 | 0.22 | 0.22 | 0.22 | 0.22 |
| Content C1 | 20% | 20% | 20% | 20% | 20% |
| Ratio R1 | 36.8% | 36.8% | 36.8% | 36.8% | 36.8% |

The cement Ce1 was a CEM 52.5R from the cement works of Lafarge Ciments located at Saint Pierre la Cour (France).

The cement Ce2 was a CEM 52.5N from the cement works of Lafarge Ciments located at Teil (France).

The cement Ce3 was a CEM 32.5R from the cement works of Lafarge Ciments located at Frangey (France).

The cement Ce4 was a CEM 42.5N from the cement works of Blue Circle located in Cauldon (England).

The cement Ce5 was a CEM 52.5N from the cement works of Lafarge Ciments located at Frangey (France).

The aggregates P were porphyry granulates or sands coming from the quarry in Rivolet (France).

The aggregates S were silico-calcareous granulates or sands coming from the quarry in Saint Laurent de Mure (France) and available from Jean Lefebvre.

The aggregates G were granitic granulates and sands coming from the quarry in Mount Sorrel (England) and available from Lafarge Aggregates.

### Example 12

Cylindrical test pieces having dimensions of 80 mm×80 mm of compositions I, J, K, L and M (according to the invention) were cast using the operating protocol of example 5.

The compressive strength tests carried out according to the operating protocol of example 5 gave the following results:

| | Compressive strength | | | | |
|---|---|---|---|---|---|
| | Test piece composition | | | | |
| Test piece | I | J | K | L | M |
| E | 12.8 MPa | 10.3 MPa | 9.6 MPa | 12.5 MPa | 9.3 MPa |
| E′ | 13.1 MPa | 9.8 MPa | 8.4 MPa | 11.8 MPa | 8.4 MPa |
| s/S | 1.02 | 0.95 | 0.88 | 0.95 | 0.91 |
| Density | 2.29 | 2.22 | 2.28 | 2.24 | 2.35 |

These examples clearly show that various emulsions and various types of cement or aggregate, in various proportions (but respecting the content C1 and the ratio R1 of the invention), may be used to implement the invention.

Test pieces satisfying the conditions of the Duriez test and having satisfactory mechanical strength were therefore obtained.

1. A wearing course or capping layer comprising a concrete obtained by the hydraulic setting and hardening of a composition comprising an unmodified bitumen emulsion, a hydraulic binder, aggregates, said aggregates including granulates, and optionally water, characterized in that, as regards the composition:
its content C1 of hydraulic binder is between 12% and 30% by weight with respect to the weight of all of the dry constituents of the composition, excluding the bitumen;
the ratio R1 of the sum of the actual volumes of unmodified bitumen and of hydraulic binder to the actual volume of aggregates is between 20% and 150%; and
the unmodified bitumen emulsion includes at least one nonionic surfactant.

2. The wearing course or capping layer as claimed in claim 1, characterized in that in the composition the hydraulic binder comprises at least one hydraulic binder chosen from the group consisting of Portland cements or equivalent, slag-based cements, aluminous cements, hydraulic road binders and ground cement clinkers.

3. The wearing course or capping layer as claimed in claim 1 or claim 2, characterized in that in the composition the unmodified bitumen emulsion comprises an unmodified bitumen chosen from the group consisting of bitumens of grades having a penetrability index between 40 and 220, bitumens of deasphalted grades, bitumens of synthetic grades, blends of these bitumens with one another and these blends plasticized with polymers.

4. The wearing course or capping layer as claimed in one of claims 1 to 3, characterized in that in the composition the water/binder mass ratio is between 0.4 and 0.7, preferably between 0.43 and 0.7.

5. The wearing course or capping layer as claimed in one of claims 1 to 3, characterized in that in the composition its water/binder mass ratio is less than 0.4, preferably less than or equal to 0.35.

6. The wearing course or capping layer as claimed in one of claims 1 to 5, characterized in that in the composition:
its hydraulic binder content is between 13% and 25% by weight with respect to the weight of all the dry constituents of the composition, with the exclusion of the bitumen; and
the ratio of the sum of the actual volumes of unmodified bitumen and hydraulic binder to the actual volume of aggregates is between 25% and 70%.

7. The wearing course or capping layer as claimed in any one of claims 1 to 6, characterized in that in the composition the unmodified bitumen emulsion comprises, expressed in percentages of the total weight of the emulsion:
30 to 70% of unmodified bitumen;
0.5 to 10% of nonionic surfactant;
0 to 5% of thickener;
0 to 1% of antifoam; and
qsp 100% of water;
the nonionic surfactant being formed from at least one nonionic surfactant chosen from the group consisting of ethylene oxide/propylene oxide copolymers, ethoxylated and/or propoxylated epoxydized surfactants, polyvinyl alcohols of molecular mass between 10 000 and 150 000, and ethoxylated fatty alcohols.

8. A process for manufacturing a wearing course or capping layer as claimed in any one of claims 1 to 7, comprising the application of the composition and the hydraulic setting and hardening of this composition.

9. The process as claimed in claim 8, characterized in that the preparation of the composition and its application are carried out cold.

10. The process as claimed in claim 8 or claim 9, in which a composition as described in claim 4 is applied by self-placement.

11. The process as claimed in claim 8 or claim 9, comprising the compacting of a composition as described in claim 5.

12. The process as claimed in any one of claims 8 to 11, comprising a step of preparing a composition useful in the wearing course or capping layer in which the hydraulic binder, the unmodified bitumen emulsion, the aggregates and optionally water are mixed in a single step.

13. The process as claimed in claim 12, characterized in that the step of preparing the composition is carried out in a central mixing plant for ready-mixed concrete or in a central mixing plant for cold mixes.

14. The use of a composition as described in one of claims 1 to 7 for the production of a wearing course or capping layer.
